(19) United States
(12) Patent Application Publication
(10) Pub. No.: US 2008/0116651 A1
(43) Pub. Date: May 22, 2008

(54) Cart

(76) Inventor: Pamela L. Simon, Ambler, PA (US)

Correspondence Address: FISH & RICHARDSON P.C., P.O. BOX 1022, MINNEAPOLIS, MN, 55440-1022, US

(21) Appl. No.: 11/560,529

(22) Filed: Nov. 16, 2006

(51) Int. Cl. B62B 3/00

(52) U.S. Cl. 280/47.34

(57) ABSTRACT

An improved shopping cart includes a retention device adapted to hold the cart in position relative to a vehicle. The retention device may include a strap with a length sufficient to hold the associated cart in operative proximity to the vehicle.

### TECHNICAL FIELD

This invention relates to wheeled devices for transporting goods, and more particularly, to wheeled carts.

### BACKGROUND

Runaway shopping carts are a known problem. In general terms, it is difficult to maintain shopping carts in a desired, stationary position when they are on wheels.

Unintended movement of shopping carts has a number of drawbacks and disadvantages associated with it. For example, in parking lots, shopping carts may unintentionally strike persons, automobiles, or other objects, resulting in unintended damage to any of the foregoing. A related disadvantage is the need to chase after a rolling shopping cart, an occurrence which not only mars the shopping experience of the individual, but may also subject him or her to move into parking lot traffic and risk being struck by moving vehicles as the cart is pursued.

The problems of unintentionally moving shopping carts are compounded when the shopping cart is used on parking lots or other surfaces which are inclined or when the shopping cans are heavily loaded.

Problems are likewise especially acute when an infant or child is being carried by the shopping cart. The shopping cart may move into the traffic lanes of a parking lot or into another situation hazardous to the child being carried by such cart. Even small, unintended movements of shopping carts relative to other objects can cause undesirable damage. Thus, for example, even when a shopping cart is relatively contained adjacent to a user's automobile, the act of unloading the cart into the automobile may cause the shopping cart to shift and strike the user's own vehicle, damaging its finish or otherwise scratching the vehicle. Vehicles adjacent to the user's vehicle are likewise subject to getting struck by slight movements of a shopping cart during its unloading into the user's vehicle.

Attempts to address the various drawbacks and disadvantages associated with shopping use have met with mixed results at best. Braking apparatus for a wheeled cart are known, especially for luggage carts. Such braking apparatus, however, have their own associated drawbacks and disadvantages. For example, such systems add to the cost and complexity of shopping carts, may sometimes interfere with nesting of such shopping carts, may be damaged during nesting or other use of the shopping carts, and may interfere with the ability to move the shopping cart readily about.

It is therefore desirable to improve the usage of shopping carts and other carts for transporting items. It is likewise desirable to minimize the drawbacks and disadvantages discussed above.

### SUMMARY OF THE INVENTION

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a cart, such as one used for shopping, equipped with a retention device;

FIG. 2 is an isometric view of one exemplary use of the shopping cart of FIG. 1;

FIGS. 3 and 4 are isometric views of another shopping cart equipped with a retention device; and

FIG. 5 is an isometric view of another implementation of a retention device for shopping carts.

### DETAILED DESCRIPTION

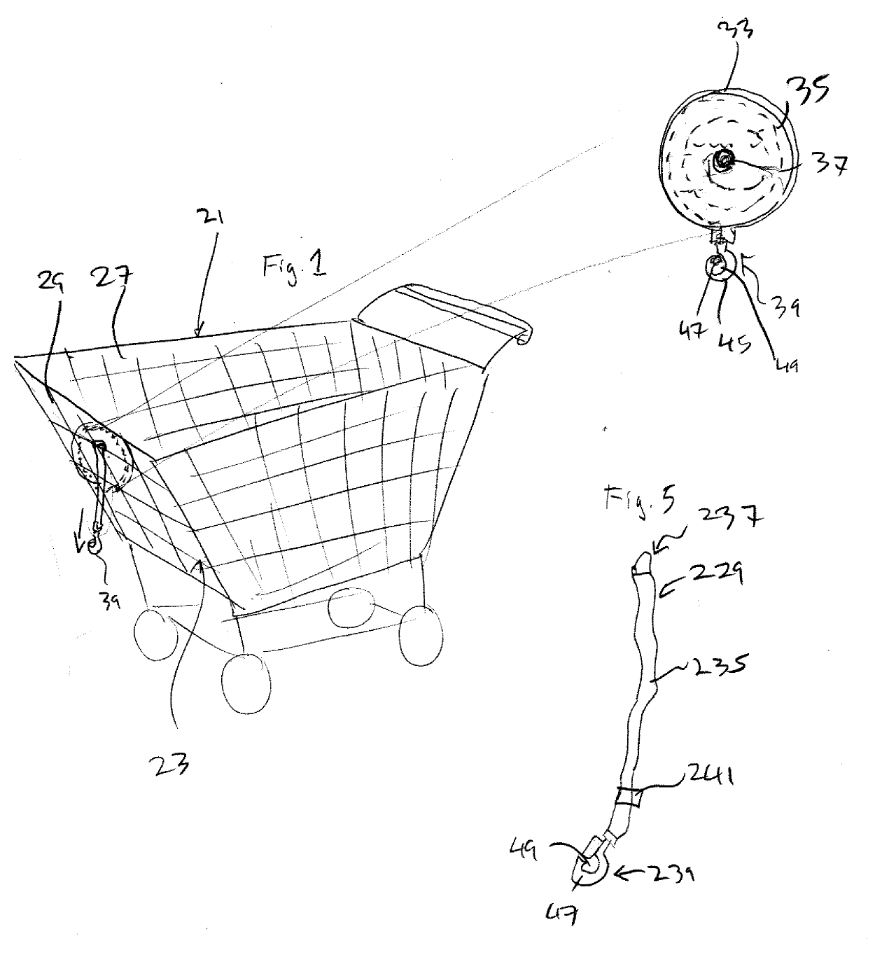

Referring now to the drawings, and in particular to FIGS. 1 and 2, a cart 21 may be suitable for a variety of carrying purposes, such as groceries, luggage, and the like. Cart 21 is rolled by the user to transport items from one place to another. For example, shopping or luggage carts generally transport items to the user's vehicle. In such application, cart 21 has locations which can be maneuvered proximate to an opposing portion of the vehicle. As shown for example in FIG. 2, one of the portions 23 (e.g. a side or corner) of cart 21 can be positioned near to the rear quarter-panel of vehicle 25 near side door opening 26 of such vehicle 25.

In this application, retention device 29 is secured to cart 21 at a suitable location so that it can also be positioned proximate to an opposing portion of vehicle 25. Thus, retention device 29 is suitably secured to one of the sides 27 of cart 21, in this case front side 31, so that the retention device 29 can be brought into operative proximity to vehicle 25.

As best seen in FIG. 1, retention device 29, in this implementation, includes a housing 33. A strap 35 is coiled within housing 33 and suitably spring-mounted to a central point or hub 37. The distal or outer end 39 of strap 35 constitutes its operative end or portion in that it may be accessed and pulled through a suitable opening 41, whereupon strap 35 rotates about hub 37 and deploys a suitable length out of housing 33. The deployment of strap 35 from housing 33 can be controlled, spring biased, or otherwise guided by any of a variety of features and structures. Thus, for example, retention device 29 can be equipped with structures which lock an operative length of strap 35 outside of housing 33 for use in conjunction with vehicle 25. Similarly, retention device 29 can be equipped with suitable mechanisms to selectively or automatically retract or deploy strap 35 from within housing 33.

Strap 33 may be formed of any suitable material strong enough to hold shopping cart 21 in position without failure. Thus, for example, strap 35 may be a web of cloth, nylon, or polymeric material. Other materials and combinations are likewise suitable.

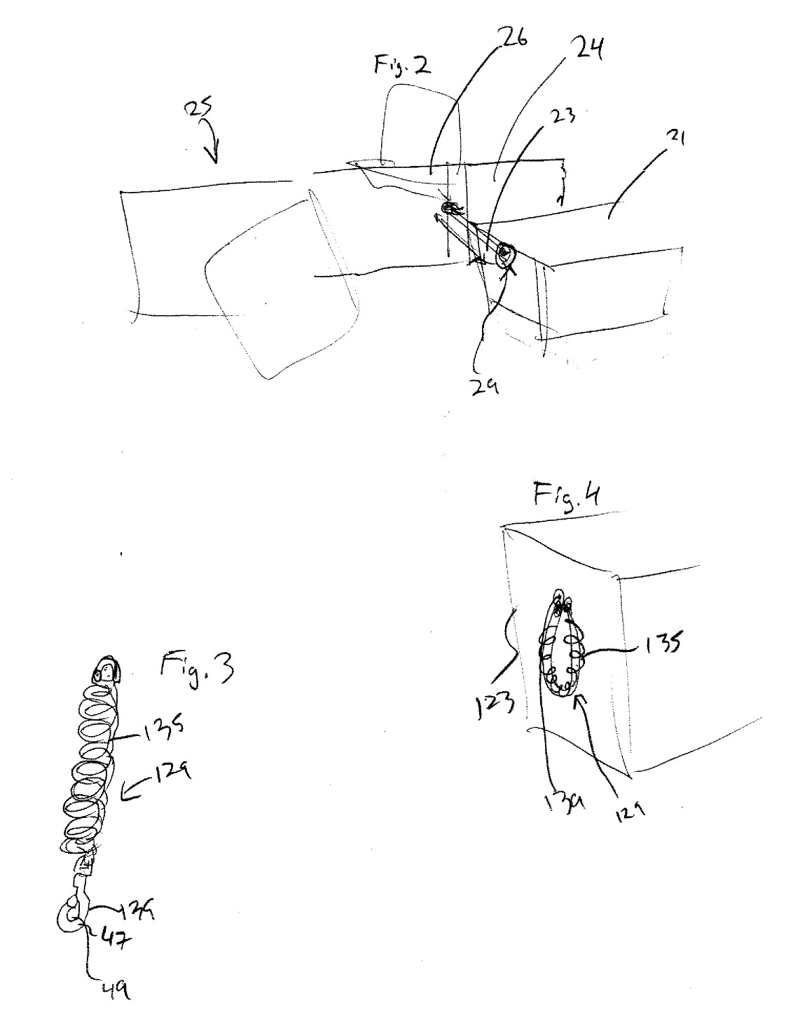

Referring now to FIGS. 3 and 4, another implementation of an improved shopping cart 121 is shown. In this implementation, retention device 129 makes use of a coiled cord 135, one portion (e.g., end) 137 of which is suitably secured to a portion 123 of cart 121 and the other, operative portion (e.g., end) 139 is adapted to be removably secured to vehicle 25.

In use, coiled cord 135 is extended a suitable amount so that cart 121 is held in operative proximity to vehicle 25. When not in use, coiled cord 135 can have its operative portion 139 hooked on or secured to a portion of cart 121 as shown in FIG. 4.

Still another implementation of an improved shopping cart hereunder is explained with reference to FIG. 5. Instead of using coiled cord 135 as explained with reference to FIGS. 3 and 4, retention device 229 includes a strap 235 formed of materials similar to those available for strap 35, but without being coiled within a housing. Strap 235 has one portion (e.g., end) 237 adapted to be secured (either removably or fixedly) to a portion of a shopping cart, whereas 239 is adapted to be removably secured to a location on vehicle 25. Strap 235 may optionally include features to adjust its overall length, such as adjustment buckle 241. As a further option, strap 235 may be formed of a slightly resilient material, such as neoprene or rubber, or may include stretchable or resilient portions therein. Strap 235 may have a variety of lengths, depending on the particular application, such length potentially factoring in the size of the cart to which it is secured, the size of the vehicles, and other operative factors. In one implementation, when cart 21 comprises any of the various grocery shopping carts prevalent at supermarkets, suitable lengths for strap 235 may range from between about twelve inches to about 36 inches, and, in one implementation, a length of about eighteen inches has been found particularly suitable for attaching to most passenger vehicles.

The operative ends or portions of the retention device adapted to be secured to a vehicle may also assume a variety forms, depending of the particular application. Thus, for example, in the illustrated implementations, the operative ends of the retention device are equipped with a hook 47, such as one with a spring-loaded recloseable eye 49. Such configuration of a hook 47 has been found suitable for selective attachment to u-shaped latches found in door jams and in trunks on many vehicles. It will be appreciated that the size and configuration of hook 47 may be further varied, and that hook 47 itself may be replaced by other devices, mechanisms, and means for removably securing the strap or cord of the retention device to the vehicle.

Thus, for example, mating Velcro portions (not shown) may be provided at the operative ends of the straps, or even a suitable magnet may be provided to be attached to a metallic portion of vehicle 25.

Retention device 29, 129, 229 may be provided as a separately attachable and detachable unit for use with a corresponding cart. This permits existing shopping carts to be retrofitted with a suitable retention device. Alternately, shopping or luggage carts may be configured to have a suitable retention device associated therewith, such device being built-in, integral, or otherwise associated with a shopping cart.

Still further, while the various implementations illustrated herein have been shown used in conjunction with vehicle 25, they are equally suitable for holding carts close to other objects, including stationary objects such as doors, windows, buildings, fences, sheds, and the like.

The use of the various shopping carts described herein is apparent from the foregoing description. A user brings the shopping cart close to his or her vehicle. The shopping cart is generally loaded with merchandise to be transferred to the vehicle. The operative portion, such as the end, of the retention device is extended from the shopping cart and removably secured to an appropriate location on the vehicle. In the illustrated implementation, the hook on the end of the strap or cord of the retention device is attached to a suitable u-shaped latch, preferably in the door jam or by the trunk or hatch of the vehicle.

Once the cart is suitably secured relative to the vehicle by the retention device, goods are transferred between the vehicle and the cart. Thus, for example, a cart loaded with groceries is emptied into the car's passenger area through one of its doors or into the cargo area or trunk through a suitable opening. Conversely, items from the vehicle may be loaded into the cart.

When the user is done performing operations or transfers of goods between the vehicle and the cart, the operative portion of the retention device can be unhooked or otherwise detached from the vehicle, and either recoiled, or returned to the cart, or left to dangle. The retention device may be removed completely form the cart after use.

It will be appreciated that one of the advantages of the improved cart is the ability to retain it relative to not only the user's car, but also other cars in a parking lot. The cart is kept from rolling away during loading and unloading into a vehicle, especially if a parking lot is inclined or otherwise sloping. Instead of having to keep one hand on a cart to maintain its position relative to the vehicle, the user is free to use both hands in loading and unloading the cart.

A number of embodiments and alternatives of the invention have been described. Nevertheless, it will be understood that still further modifications may be made without departing from the spirit and scope of the invention. Accordingly, other embodiments are within the scope of the following claims.

What is claimed is:

1. A shopping cart comprising:
portions defining a contained area for receiving a load therein;
wheels for moving the contained area over a surface to within proximity of a vehicle;
a retention device associated with the contained area and having an operative portion removably securable to the vehicle to retain the contained area in proximity thereto.

2. The art of claim 1, wherein the retention device includes a strap having attachment means at one of its ends.

3. The cart of claim 1, wherein the retention device includes a housing and a strap at least partially received therein, the strap having an end extendable from the housing, the end having attachment means thereon.

4. The cart of claim 1, wherein the retention device includes a strap having opposite ends, one of the ends secure to the contained area, the other of the ends having attachment means thereon.

5. The cart of claim 4, wherein the attachment means comprises a hook.

6. A retention device for securing a wheeled cart relative to a stationery object, the retention device comprising:
an operative portion removably securable to the stationery object to retain the cart in proximity thereto;
wherein the retention device comprises a strap having attachment means located on the operative portion.

7. The retention device of claim 6, wherein the strap has a first end, the operative portion located at the first end, and a second end to secure to the cart.

8. The retention device of claim 7, wherein the attachment means comprises a hook.

9. A method of retaining a wheeled shopping cart in proximity to a vehicle, the method comprising:
securing an operative portion of a strap to a location on the vehicle, the strap having another portion spaced from the operative portion which is secured to the cart.

10. The method of claim 9, wherein securing the operative portion includes hooking an end of the strap onto a pre-existing latch of the vehicle, the latch located proximate to a door, trunk or hatch of the vehicle.

11. The method of claim 9, wherein securing the operative portion includes extending an attachment means from the cart toward the vehicle.

12. The method of claim 11, wherein extending the attachment means includes unhooking the attachment means from the contained area.

13. The method of claim 11, wherein extending the attachment means includes uncoiling the strap from a housing.
